(19) United States
(12) Patent Application Publication
(10) Pub. No.: US 2026/0031585 A1
(43) Pub. Date: Jan. 29, 2026

(54) ELECTRICAL ADAPTERS AND METHODS OF MANUFACTURE AND USE THEREOF

(71) Applicant: DiversiTech Corporation, Duluth, GA (US)

(72) Inventors: Thomas Wouters, Duluth, GA (US); Dave Picard, Duluth, GA (US)

(21) Appl. No.: 18/995,060

(22) PCT Filed: Jul. 28, 2023
(86) PCT No.: PCT/US23/28918

§ 371 Date: Jan. 15, 2025

Related U.S. Application Data
(60) Provisional application No. 63/393,663, filed on Jul. 29, 2022.

(51) Int. Cl. H01R 31/06; H01R 13/02; H01R 13/10; H01R 13/50

(52) U.S. Cl. CPC H01R 31/06; H01R 13/025; H01R 13/10; H01R 13/50

(57) ABSTRACT

This disclosure enables an electrical adapter and methods of manufacture and use thereof. For example. some of electrical adapters include a housing hosting a female spade terminal and a push-in wire terminal. The female spade terminal is electrically coupled with the push-in wire terminal.

### CROSS-REFERENCE TO RELATED PATENT APPLICATION

This patent application claims a benefit of priority to U.S. Provisional Patent Application 63/393,663 filed on 29 Jul. 2022, which is incorporated by reference herein for all purposes.

### TECHNICAL FIELD

This disclosure relates to electrical adapters. More particularly, this disclosure relates to electrical adapters to be used for electrically connecting loads, for example, in heating, ventilation, and air conditioning (HVAC) applications and other applications.

### BACKGROUND

There is a desire to have an electrical adapter between a first electrical connection of a first configuration and a second electrical connection of a second configuration different from the first configuration. However, the electrical adapter is not known to exist as of today.

### SUMMARY

This disclosure enables various electrical adapters and methods of manufacture and use thereof. These electrical adapters adapt between first electrical connections of first configurations and second electrical connections of second configurations different from the first configurations.

In an embodiment, there is a device, comprising: an electrical adapter having a housing hosting a female spade terminal and a push-in wire terminal, wherein the female spade terminal is electrically coupled with the push-in wire terminal.

In an embodiment, there is a method, comprising: enabling an end user to: access an electrical adapter having a housing hosting a female spade terminal and a push-in wire terminal, wherein the female spade terminal is electrically coupled with the push-in wire terminal; extend a male spade terminal in the female spade terminal and an electrical conductor in the push-in wire terminal; and energize the male spade terminal while the male spade terminal extends in the female spade terminal or the electrical conductor while the electrical conductor extends in the push-in wire terminal.

In an embodiment, there is a method, comprising: manufacturing an electrical adapter having a housing hosting a female spade terminal and a push-in wire terminal, wherein the female spade terminal is electrically coupled with the push-in wire terminal such that a male spade terminal is extendable in the female spade terminal and an electrical conductor is extendable in the push-in wire terminal and the male spade terminal is energizable while the male spade terminal extends in the female spade terminal or the electrical conductor is energizable while the electrical conductor extends in the push-in wire terminal.

### DESCRIPTION OF DRAWINGS

FIG. 1 is a perspective view of an embodiment of an electrical adapter according to this disclosure.

FIG. 2 is a profile view of an embodiment of an electrical adapter depicted in FIG. 1 according to this disclosure.

FIG. 3 is a cutaway view of an embodiment of an electrical adapter depicted in FIGS. 1-2 according to this disclosure.

FIG. 4 is a cross-sectional view of an embodiment of an electrical adapter depicted in FIGS. 1-3 according to this disclosure.

FIG. 5 is a profile view of an embodiment of an electrical adapter depicted in FIGS. 1-4 with a cross-sectional line according to this disclosure.

FIG. 6 is a frontal view of an embodiment of an electrical adapter depicted in FIGS. 1-5 showing a female spade terminal according to this disclosure.

FIG. 7 is a frontal view of an embodiment of an electrical adapter depicted in FIGS. 1-6 showing a push-in wire terminal according to this disclosure.

FIG. 8 is an isometric view of an embodiment of a schematic of an electrical adapter depicted in FIGS. 1-7 according to this disclosure.

FIG. 9 is a perspective view of an embodiment of a schematic of an electrical adapter depicted in FIGS. 1-8 to be engaged with a pair of electrical wires extending from a first device and a male spade terminal extending from a second device according to this disclosure.

FIG. 10 is a perspective view of an embodiment of a schematic of a pair of electrical adapters, each as respectively depicted in FIGS. 1-8, each to respectively receive a pair of wires and each to respectively mate with a male spade terminal according to this disclosure.

FIG. 11 is a perspective view of a set of embodiments of a set of electrical adapters, each depicted in FIGS. 1-8, that differ from each other in an amount of spade terminals or an amount of push-in wire terminals according to this disclosure.

FIG. 12 is a perspective view of an embodiment of an electrical adapter depicted in FIGS. 1-8 according to this disclosure.

FIG. 13 is a perspective view of an embodiment of an electrical adapter depicted in FIGS. 1-8 and 12 according to this disclosure.

FIG. 14 is a perspective view of an embodiment of an electrical adapter according to this disclosure.

### DETAILED DESCRIPTION

As explained above, this disclosure enables various electrical adapters and methods of manufacture and use thereof. These electrical adapters adapt between first electrical connections of first configurations and second electrical connections of second configurations different from the first configurations. This disclosure is now described more fully with reference to the drawings, in which some embodiments of this disclosure are shown. This disclosure may, however, be embodied in many different forms and should not be construed as necessarily being limited to various embodiments disclosed herein. Rather, these embodiments are provided so that this disclosure is thorough and complete, and fully conveys various concepts of this disclosure to skilled artisans. Note that like numbers or similar numbering schemes can refer to like or similar elements throughout.

Various terminology used herein can imply direct or indirect, full or partial, temporary or permanent, action or inaction. For example, when an element is referred to as being “on,” “connected” or “coupled” to another element, then the element can be directly on, connected or coupled to the other element or intervening elements can be present, including indirect or direct variants. In contrast, when an element is referred to as being “directly connected” or “directly coupled” to another element, there are no intervening elements present.

Various singular forms “a,” “an” and “the” are intended to include various plural forms (e.g., two, three, four, five, six, seven, eight, nine, ten, tens, hundreds, thousands) as well, unless specific context clearly indicates otherwise.

Various presence verbs “comprises,” “includes” or “comprising,” “including” when used in this specification, specify a presence of stated features, integers, steps, operations, elements, or components, but do not preclude the presence or addition of one or more other features, integers, steps, operations, elements, components, or groups thereof.

As used herein, a term “or” is intended to mean an inclusive “or” rather than an exclusive “or.” That is, unless specified otherwise, or clear from context, “X employs A or B” is intended to mean any of a set of natural inclusive permutations. That is, if X employs A; X employs B; or X employs both A and B, then “X employs A or B” is satisfied under any of the foregoing instances.

As used herein, a term “or others,” “combination”, “combinatory,” or “combinations thereof” or another conceptually similar terminology refers to all permutations and combinations of listed items preceding that term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. Skilled artisans understand that typically there is no limit on number of items or terms in any combination, unless otherwise contextually apparent.

Unless otherwise defined, all terms (including technical and scientific terms) used herein have the same meaning as commonly understood by one of ordinary skill in an art to which this disclosure belongs. Various terms, such as those defined in commonly used dictionaries, should be interpreted as having a meaning that is consistent with a meaning in a context of a relevant art and should not be interpreted in an idealized or overly formal sense, unless expressly so defined herein.

Relative terms such as “below,” “lower,” “above,” and “upper” can be used herein to describe one element's relationship to another element as illustrated in the set of accompanying illustrative drawings. Such relative terms are intended to encompass different orientations of illustrated technologies in addition to an orientation depicted in the set of accompanying illustrative drawings. For example, if a device in the set of accompanying illustrative drawings were turned over, then various elements described as being on a “lower” side of other elements would then be oriented on “upper” sides of other elements. Similarly, if a device in one of illustrative figures were turned over, then various elements described as “below” or “beneath” other elements would then be oriented “above” other elements. Therefore, various example terms “below” and “lower” can encompass both an orientation of above and below.

As used herein, a term “about” or “substantially” refers to a +/−10% variation from a nominal value/term. Such variation is always included in any given value/term provided herein, whether or not such variation is specifically referred thereto.

Although the terms first, second, can be used herein to describe various elements, components, regions, layers, or sections, these elements, components, regions, layers, or sections should not necessarily be limited by such terms. These terms are used to distinguish one element, component, region, layer or section from another element, component, region, layer or section. Thus, a first element, component, region, layer, or section discussed below could be termed a second element, component, region, layer, or section without departing from various teachings of this disclosure.

Features described with respect to certain example embodiments can be combined and sub-combined in or with various other example embodiments. Also, different aspects or elements of example embodiments, as disclosed herein, can be combined and sub-combined in a similar manner as well. Further, some example embodiments, whether individually or collectively, can be components of a larger system, wherein other procedures can take precedence over or otherwise modify their application. Additionally, a number of steps can be required before, after, or concurrently with example embodiments, as disclosed herein. Note that any or all methods or processes, at least as disclosed herein, can be at least partially performed via at least one entity in any manner.

Example embodiments of this disclosure are described herein with reference to illustrations of idealized embodiments (and intermediate structures) of this disclosure. As such, variations from various illustrated shapes as a result, for example, of manufacturing techniques or tolerances, are to be expected. Thus, various example embodiments of this disclosure should not be construed as necessarily limited to various particular shapes of regions illustrated herein. but are to include deviations in shapes that result, for example, from manufacturing.

Any or all elements, as disclosed herein, can be formed from a same, structurally continuous piece, such as being unitary or monolithic, or be separately manufactured or connected, such as being an assembly or modules. Any or all elements, as disclosed herein, can be manufactured via any manufacturing processes, whether additive manufacturing, subtractive manufacturing, or other any other types of manufacturing. For example, some manufacturing processes include three dimensional (3D) printing. laser cutting, computer numerical control routing, milling, pressing, stamping, vacuum forming, hydroforming, injection molding, lithography, chiseling, cutting, and so forth.

Hereby, all issued patents, published patent applications, and non-patent publications that are mentioned or referred to in this specification are herein incorporated by reference in their entirety for all purposes, to a same extent as if each individual issued patent, published patent application, or non-patent publication were specifically and individually indicated to be incorporated by reference. To be even more clear, all incorporations by reference specifically include those incorporated publications as if those specific publications are copied and pasted herein, as if originally included in this disclosure for all purposes of this disclosure. Therefore, any reference to something being disclosed herein includes all subject matter incorporated by reference, as explained above. However, if any disclosures are incorporated herein by reference and such disclosures conflict in part or in whole with this disclosure, then to an extent of the conflict or broader disclosure or broader definition of terms, this disclosure controls. If such disclosures conflict in part or in whole with one another, then to an extent of conflict, the later-dated disclosure controls.

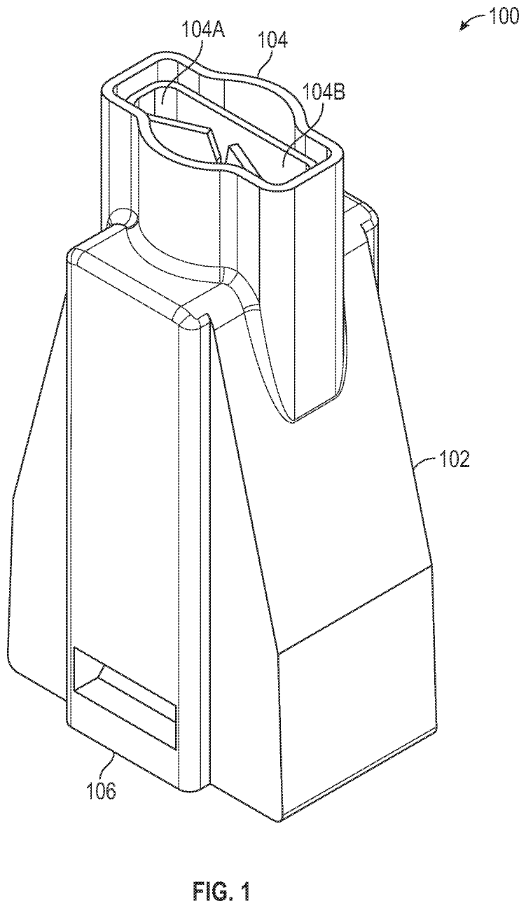

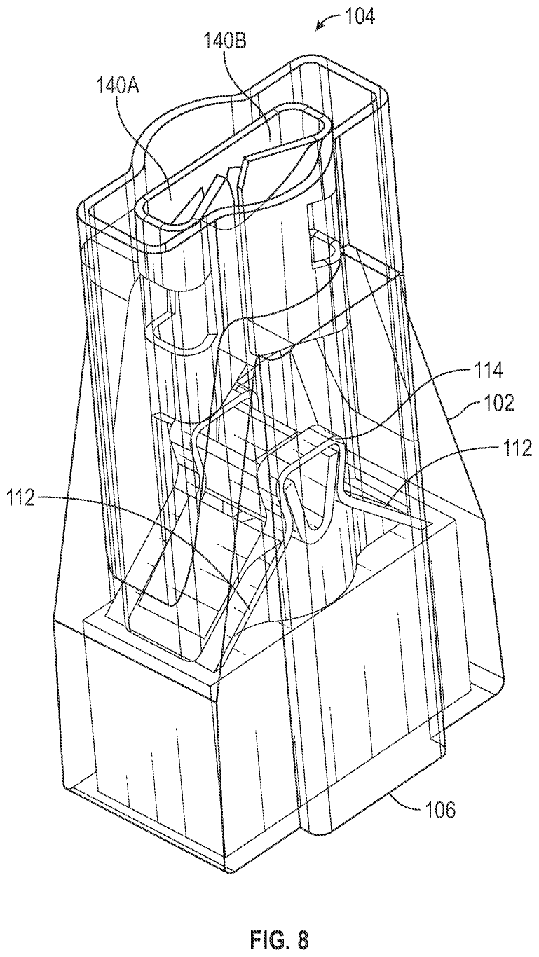

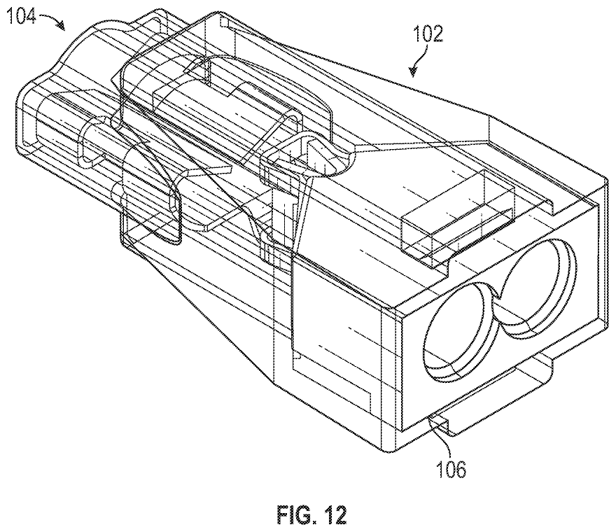

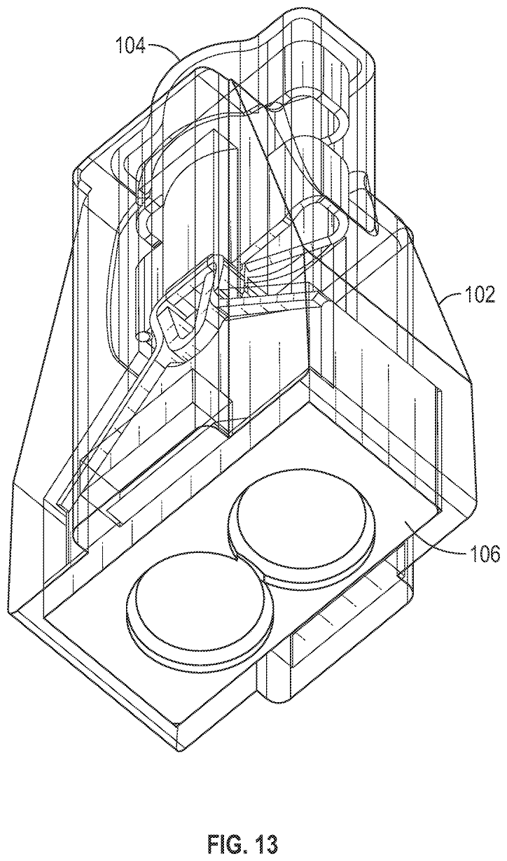

FIG. 1 is a perspective view of an embodiment of an electrical adapter according to this disclosure. FIG. 8 is an isometric view of an embodiment of a schematic of an electrical adapter depicted in FIGS. 1-7 according to this disclosure. FIG. 12 is a perspective view of an embodiment of an electrical adapter depicted in FIGS. 1-8 according to this disclosure. FIG. 13 is a perspective view of an embodiment of an electrical adapter depicted in FIGS. 1-8 and 12 according to this disclosure. In particular, an electrical adapter 100 includes a housing 102, a female spade terminal 104, and a push-in wire terminal 106.

The housing 102 may host (e.g., house) the female spade terminal 104 and the push-in wire terminal 106, whether internally or externally, whether permanently or temporarily (e.g., removably, detachably). The housing 102 may host (e.g., house) an electrical conductor (or a set of suitable circuitry), whether internally or externally, whether permanently or temporarily (e.g., removably, detachably), such that the electrical conductor electrically couples (e.g., connects) the female spade terminal 104 with the push-in wire terminal 106 or vice versa, whether internal to the housing 102 or external to the housing 102, whether permanently or temporarily (e.g., removably, detachably).

The housing 102 may be a sleeve, a tube, a box, or another suitable enclosure, which may constitute of an electrically insulative material, such as plastic, rubber, ceramic, composite polymer, glass, or another suitable material that may inhibit at least some transfer of an electrical charge from within the housing 102 to outside the housing 102 or vice versa. However, note that the housing 102 may constitute of an electrically conductive material, such as a metal, an alloy, copper, aluminum, gold, or another suitable material that may have a property that enables a flow of electrons.

The housing 102 may include a portion that is optically transparent, but this configuration is not required and the portion may be optically translucent or optically opaque, whether the portion is the housing 102 entirely or less than entirely (e.g., a side). Although the housing 102 may be rigid (e.g., unable to be manually bent by hand), this configuration is not required and the housing 102 may be flexible (e.g., able to be manually bent by hand). For example, the housing 102 may constitute a rigid material (e.g., hard plastic, hard metal, hard alloy), which may enable the female spade terminal 104 and the push-in wire terminal 106 to be permanently spaced apart from each other, or a flexible material (e.g., pliable rubber, soft metal, shape-memory material), which may enable the female spade terminal 104 and the push-in wire terminal 106 to be dynamically spaced apart from each other as needed (e.g., manual bend between 0 degrees and 180 degrees) and persist in that state as needed. Note that the female spade terminal 104 and the push-in wire terminal 106 may also be dynamically spaced apart from each other as needed and persist in that state as needed when the housing 106 includes a pivot point (e.g., a hinge, a mechanical hinge, a living hinge) about which the housing 102 is accordingly adjustable.

The housing 102 may be sized and dimensioned to be handheld during use. For example, the housing 102 may be sized and dimensioned to be handheld when the female spade terminal 104 is mated with a corresponding male spade terminal. For example, the housing 102 may be sized and dimensioned to be handheld when the push-in wire terminal 106 receives a solid electrical conductor (e.g., a wire), a stranded (e.g., braided) electrical conductor (e.g., a wire), a solid electrical conductor and a stranded electrical conductor, or a combination or a hybrid of the solid electrical conductor and the stranded electrical conductor. However, note that this form factor is not required and the housing 102 can be sized and dimensioned not to be handheld, portable, or mobile.

The housing 102 may have a first end portion hosting (e.g., by fastening, mating, adhering, friction fitting, magnetizing, bonding) the female spade terminal 104 and a second end portion hosting the push-in wire terminal 106. The first end portion may oppose the second end portion directly along a common plane (e.g., vertical, horizontal, diagonal). However, this configuration is not required and the first end portion and the second end portion may not oppose the second end portion directly along the common plane (e.g., angled less than 180 degrees between each other which includes all angles between 0 degrees and 180 degrees) or there may be more than two end portions, whether angled at 180 degrees between each other or less which includes all angles between 0 degrees and 180 degrees. For example, the housing 102 may be L-shaped, U-shaped, V-shaped, J-shaped. W-shaped, M-shaped, N-shaped, T-shaped, Y-shaped, H-shaped, S-shaped, F-shaped, K-shaped, C-shaped, X-shaped, or any other suitable shape, whether open or closed, whether symmetrical or asymmetrical, whether polygonal, spherical, toroid, cube, cuboid, pyramidal, conical, or any other suitable shape. As such, the housing 102 may have an end portion with single or multiple (e.g., two, three, four, five, six, seven, eight, nine, ten, tens, hundreds) female spade terminals 104 or single or multiple (e.g., two, three, four. five, six, seven, eight, nine, ten. tens, hundreds) push-in wire terminals 106. For example, the housing 102 may have a one-to-many correspondence between the spade terminal 104 and the push-in wire terminals 106 or vice versa. For example, the housing 102 may have a many-to-many correspondence between the spade terminals 104 and the push-in wire terminals 106 or vice versa. For example, the housing 102 may have a many-to-one correspondence between the spade terminals 104 and the push-in wire terminal 106 or vice versa. For example, the housing 102 may have a one-to-one correspondence between the spade terminal 104 and the push-in wire terminal 106 or vice versa. For example, the housing 102 may have the female spade terminals 104 or the push-in wire terminals 106 of a same ratio or amount (e.g., two-two, three-three, four-four, even amount-even amount, odd amount-odd amount), or of a different ratio or amount (e.g., even amount-odd amount, odd amount-even amount, two-three, four-two, eight-one and so forth whether the female spade terminals 104 to the push-in wire terminals 106 or vice versa).

The female spade terminal 104 (e.g., a receiving or depressive electrical portion of a FASTON connector) may be configured to establish a secure but detachable connection with the corresponding male spade terminal (e.g., an inserting or projective electrical portion of a FASTON connector) of a power source, such as a circuit breaker electrically connected to an electrical grid, a contactor, or of another suitable electrical source or an electrical load. For example, the corresponding male spade terminal may include a plate with a bore (e.g., O-shaped, 0-shaped, D-shaped) therethrough, where the plate constitutes of an electrically conductive material (e.g., metal, alloy, copper, aluminum, gold). The female spade terminal 104 is disposed or otherwise positioned or located at the first end portion of the housing 102. When the corresponding male spade terminal and the female spade terminal 104 are electrically connected and mechanically mating, there is an electrical connection formed. The female spade terminal 104 may include a first electrical connection zone 104A and a second electrical connection zone 104B. Each of the first electrical connection zone 104A and second electrical connection zone 104B may be configured to physically contact an electrically conductive component of the corresponding male spade terminal when the female spade terminal 104 mates with the corresponding male spade terminal. For example, the first electrical connection zone 104A and the second electrical connection zone 104B may be designed to secure a physical contact formed by mating via a crimping action or a soldering action that may make the physical contact more durable mechanically or electrically. For example, the first electrical connection zone 104A and the second electrical connection zone 104B may be configured to secure the physical contact with a fastening member, such as a screw, a bolt, a nut, a clip, a bracket, a latch, a mechanical connector, or another suitable mechanical retention, fastening, mating, interlocking, adhering, magnetizing, or securing mechanism.

The housing 102 has the second end portion hosting (e.g., by fastening, mating, adhering, friction fitting, magnetizing, bonding) the push-in wire terminal 106 (e.g., a Wago PUSH WIRE® connector), which may or may not be directly opposite the female spade terminal 104 disposed at the first end portion of the housing 102. The push-in wire terminal 106 may include a receptacle configured to receive the solid electrical conductor (e.g., a wire), the stranded (e.g., braided) electrical conductor (e.g., a wire), the solid electrical conductor and the stranded electrical conductor, or the combination or the hybrid of the solid electrical conductor and the stranded electrical conductor. The solid electrical conductor may be a single, solid piece, such as a wire including copper, aluminum, gold, or another suitable metal, alloy, or electrically conductive material. The solid electrical conductor may be used in applications where strength and durability are prioritized more than flexibility. The stranded electrical conductor may be composed of numerous smaller individual conductors that are woven or braided together, such as by twisting, rolling, or braiding strands of wire together, which may be helical. The stranded electrical conductor may be used in applications where flexibility is prioritized more than strength and durability.

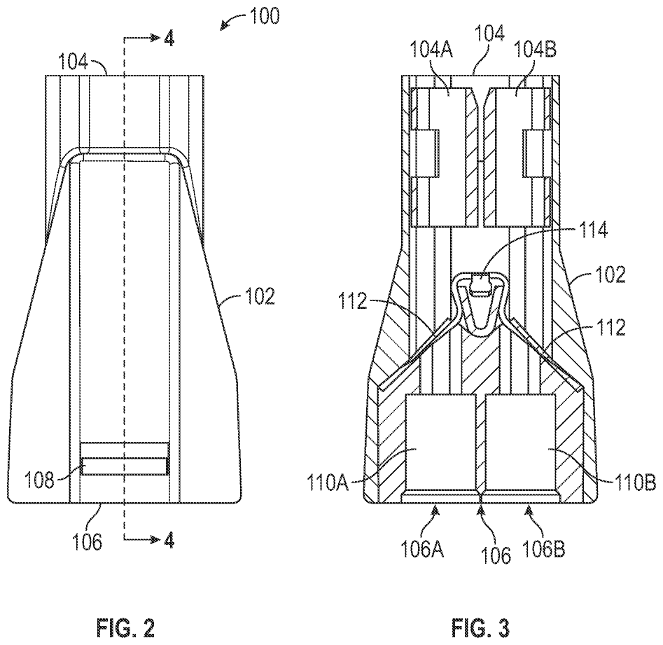

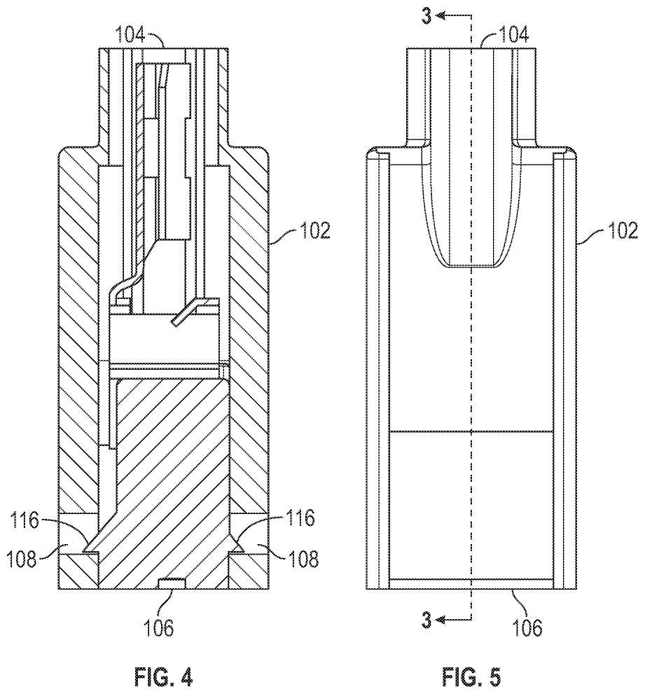

FIG. 2 shows a profile view of an embodiment of an electrical adapter depicted in FIG. 1 according to this disclosure. FIG. 4 is a cross-sectional view of an embodiment of an electrical adapter depicted in FIGS. 1-3 according to this disclosure. In particular, the electrical adapter 100 includes the housing 102 that internally houses, whether partially or fully, or internally encloses, whether partially or fully, the female spade terminal 104 or the push-in wire terminal 106. However, this configuration is not required and the female spade terminal 104 or the push-in wire terminal 106 can be externally hosted by the housing 102, whether partially or fully.

There is illustrated a cross-sectional cut line 4-4, which depicts the housing 102 as cross-sectionally cut along the cross-sectional cut line 4-4 to depict FIG. 4. Therefore, the push-in wire terminal 106 may have a projection or a protrusion 116 extending (e.g., radially) therefrom within the housing 102, as shown in FIG. 4, although this configuration may be omitted. As such, the housing 102 may include a terminal retention zone 108 (e.g., a side, a wall) configured to physically (e.g., mechanically) retain the push-in wire terminal 106 via the projection or the protrusion 116 engaging (e.g., latching) against the terminal retention zone 108 such that the push-in wire terminal 106 remains positioned within the housing 102 or hosted by the housing 102. as shown in FIG. 4, although this configuration may be omitted. For example, the terminal retention zone 108 may receive the projection or the protrusion 116, such as shown in FIG. 4. As such, by receiving the projection or the protrusion 116, the terminal retention zone 108 prevents the push-in wire terminal 106 from disengaging with the housing 102. The projection or the protrusion 116 (e.g., an acutely angled portion) is depicted engaging against the terminal retention zone 108 to keep the push-in wire terminal 106 secure within the housing 102. Although the projection or the protrusion 116 is depicted as one on each side (left and right), this configuration is not required and there may be a single projection or protrusion (e.g., a spike, a collar) or there may be multiple projections or protrusions (e.g., radially or helically extending).

FIG. 3 is a cutaway view of an embodiment of an electrical adapter depicted in FIGS. 1-2 according to this disclosure. FIG. 5 is a profile view of an embodiment of an electrical adapter depicted in FIGS. 1-4 with a cross-sectional line according to this disclosure. In particular, there is a cross-sectional cut line 3-3, which depicts the housing 102 as cross-sectionally cut along the cross-sectional cut line 5-5 to depict FIG. 3. The female spade terminal 104 includes the first electrical connection zone 104A and the second electrical connection zone 104B that are configured to receive the corresponding male spade terminal.

The housing 102 has the second end portion hosting (e.g., housing) the push-in wire terminal 106A and the push-in terminal 106B, although less push-in wire terminals 106 (e.g., one) or more push-in wire terminals 106 (e.g., three, four, five) are possible, whether per single end portion or distributed among multiple end portions. The push-in wire terminal 106A includes a first receptacle 110A (e.g., a channel, a cavity) configured for receiving and hosting (e.g., permanently, temporarily, removably, detachably) a first electrical conductor (e.g., a solid wire, a stranded wire). The push-in wire terminal 106B includes a second receptacle 110B (e.g., a channel, a cavity) configured for receiving and hosting (e.g., permanently, temporarily, removably, detachably) a second electrical conductor (e.g., a solid wire, a stranded wire). The first receptacle 110A may be positioned to receive or host the first electrical conductor parallel to the second receptacle 110B receiving or hosting the second electrical conductor, although this configuration is not required and the first receptacle 110A may be positioned to receive or host the first electrical conductor not parallel to the second receptacle 110B receiving or hosting the second electrical conductor. Although the first receptacle 110A and the second receptacle 110B may be commonly positioned at the second end portion of the housing 102, this configuration is not required and the first receptacle 110A and the second receptacle 110B may be positioned at different end portions of the housing 102 (e.g., a Y-shape, a T-shape).

The housing 102 may include a tapering portion 112 (e.g., a pyramidal portion, a conical portion). As such, the tapering portion 112 may include the second end portion hosting the push-in wire terminal 106A with the first receptacle 110A and the push-in wire terminal 106B with the second receptacle 110B. Therefore, the tapering portion 112 may host (e.g., house) the first electrical conductor when the first electrical conductor is hosted in the first receptacle 110A and the second electrical conductor when the second electrical conducted is hosted in the second receptacle 110B. Note that the housing 102 may omit the tapering portion 112. For example, the housing may be shaped as a cube, a cuboid, an ovoid, a sphere, or another suitable shape.

The housing 102 may host (e.g., house) an electrical connector 114 (e.g., a contact, a wire, a switch) that electrically connects (e.g., bridges) the female spade terminal 104 and the push-in wire terminal 106A or the push-in wire terminal 106B, whether directly or indirectly, whether internally or externally, whether permanently or temporarily (e.g., detachably, removably), to provide a common electrical path between the female spade terminal 104 and the push-in wire terminal 106A or push-in wire terminal 106B. The electrical connector 114 may be hosted by fastening, mating, adhering, friction fitting, magnetizing, bonding, or otherwise securing with the housing 102, whether internally or externally, whether permanently or temporarily (e.g., detachably, removably). Therefore, the electrical connector 114 may enable the first receptacle 110A hosting the first electrical conductor or the second receptacle 110B hosting the second electrical conductor to be electrically connected to the corresponding male spade terminal mating with the female spade terminal 104, or vice versa. Note that this configuration may vary and the electrical connector 114 may provide multiple electrical paths between the female spade terminal 104 and the push-in wire terminal 106A or push-in wire terminal 106B. For example, the electrical connector 114 may electrically connect the first receptacle 110A to the first electrical connection zone 104A and the second receptacle 110B may electrically connect to the second electrical connection zone 110B. For example, the housing 102 may host (e.g., house) an electrical switch that may switch between multiple electrical paths between the female spade terminal 104 and the push-in wire terminal 106A or push-in wire terminal 106B, whether such switching is manual or automatic.

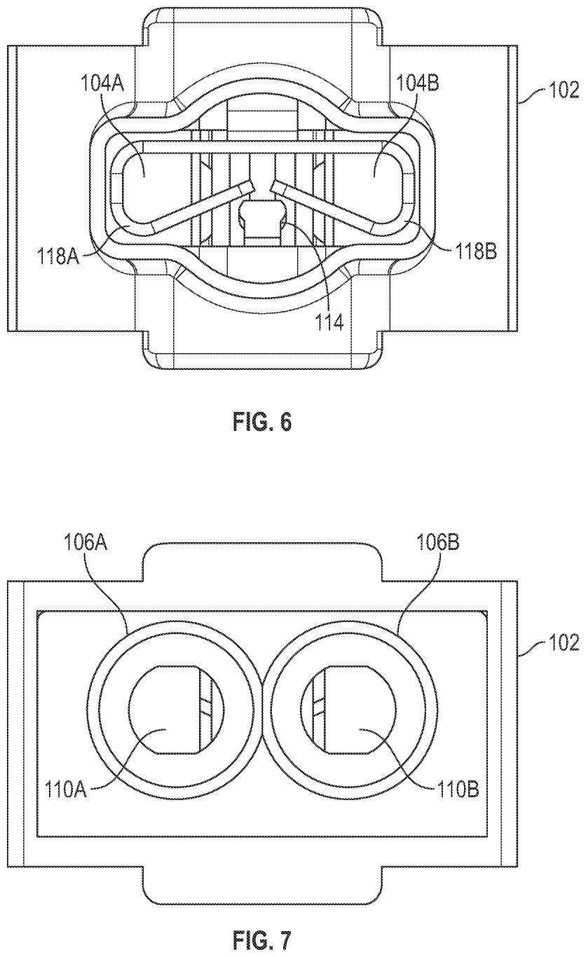

FIG. 6 is a frontal view of an embodiment of an electrical adapter depicted in FIGS. 1-5 showing a female spade terminal according to this disclosure. In particular, the housing 102 may host the female spade terminal 104 having the first electrical connection zone 104A and the second electrical connection zone 104B, where the electrical connector 114 electrically connects (e.g., bridges) the female spade terminal 104 and the push-in wire terminal 106, whether directly or indirectly, whether internal to the housing 102 or external to the housing 102, whether permanent or temporary (e.g., detachable, removable). As explained above, the electrical connector 114 provides the common electrical path between the push-in wire terminal 106 and the female spade terminal 104 and enables a flow of electrons (e.g., an electric current) from the female spade terminal 104 to the push-in wire terminal 106 or vice versa.

The female spade terminal 104 includes a base, a first spade coupler 118A, and a second spade coupler 118B. The base has a first lateral side and a second lateral side, where the first spade coupler 118A (e.g., a curved piece, an L-shaped piece, a J-shaped piece) extends from the first lateral side and the second spade coupler 118B (e.g., a curved piece, an L-shaped piece, a J-shaped piece) extends from the second lateral side, such that the base the first spade coupler 118A, and the second spade coupler 118B define a cavity configured to receive the corresponding male spade terminal to mate with the female spade terminal 104. The first spade coupler 118A and the second spade coupler 118B may respectively define the first electrical connection zone 104A and the second electrical connection zone 104B. Although the female spade terminal 104 is a single female spade terminal 104, this configuration is not required and the housing 102 may host (e.g., house) multiple female spade terminals 104, whether an odd amount or an event amount, whether on a single end portion or distributed among multiple end portions.

FIG. 7 is a frontal view of an embodiment of an electrical adapter depicted in FIGS. 1-6 showing a push-in wire terminal according to this disclosure. In particular, the housing 102 may host the push-in wire terminal 106A having the first receptacle 110A configured to receive and host the first electrical conductor and the push-in wire terminal 106 having the second receptacle 110B configured to receive and host the second electrical conductor, which may be hosted in the second receptacle 110B parallel to the first conductor being hosted in the first receptacle 110A, although this form of orientation is not required and non-parallel orientation is possible. Although the push-in wire terminal 106A includes the first receptacle 110A and the push-in wire terminal 106B includes the second receptacle 110B, this configuration is not required and the housing 102 may host (e.g., house) a single push-in wire terminal 106 or three push-in wire terminal 106 or more, whether an odd amount or an event amount. For example, there may be two, three, four, five, six, seven, eight, nine, ten, tens, hundred, hundreds, thousand, or thousands of push-in wire terminals 106, as needed.

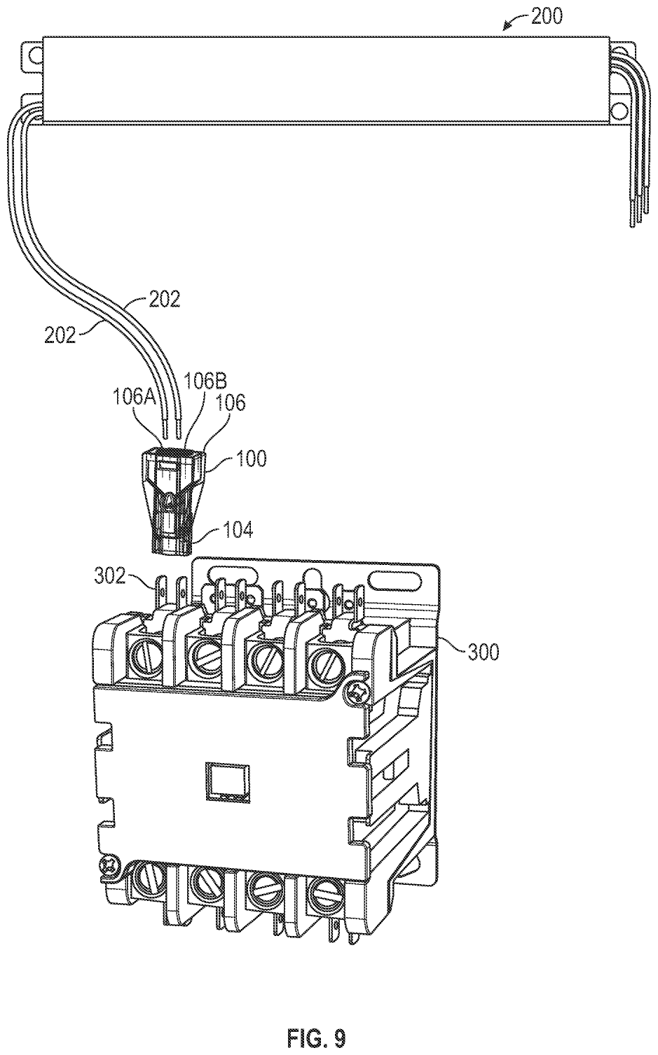

FIG. 9 is a perspective view of an embodiment of a schematic of an electrical adapter depicted in FIGS. 1-8 to be engaged with a pair of electrical wires extending from a first device and a male spade terminal extending from a second device according to this disclosure. In particular, the electrical adapter 100 may be used with a first device 200 and a second device 300.

The first device 200 may be an electrical ballast, although other suitable electrical devices are possible. For example, the first device 200 may include an electrical load (e.g., a motor, an actuator, a pump, a heating element, a fan, a blower, a valve, a sensor, a light source, a sound source, a vibration source, a fluid source), an electrical switch, a power source (e.g., a battery, a capacitor, an electrical outlet), an electrical contactor, an electrical transformer, an electrical generator, or another suitable electrical device. The first device 200 may host a pair of electrical wires 202 extending therefrom, whether solid. stranded, a hybrid of solid and stranded, or other suitable conductors. For example, the first device 200 may be a component of an HVAC system, although other applications are possible (e.g., a manufacturing system, an electrical system. a plumbing system, a vehicular system).

The second device 300 may be an electrical contactor, although other suitable electrical devices are possible. For example, the second device 300 may include an electrical load (e.g., a motor. an actuator, a pump, a heating element, a fan, a blower, a valve, a sensor, a light source, a sound source, a vibration source, a fluid source). an electrical switch, a power source (e.g., a battery, a capacitor, an electrical outlet), an electrical ballast, an electrical transformer, an electrical generator, or another suitable electrical device. The second device 300 may host a male spade terminal 302 extending therefrom. For example, the second device 300 may be a component of an HVAC system, although other applications are possible (e.g., a manufacturing system, an electrical system, a plumbing system, a vehicular system).

The electrical adapter 100 may have the housing 102 hosting a pair of push-in wire terminals 106A and 106B and the female spade terminal 104, as explained above. Therefore, the pair of push-in wire terminals 106A and 106B may receive and host the pair of wires 202 (one-to-one), as explained above. Likewise, the female spade terminal 104 may receive and host the male spade terminal 302. Note that this sequence of actions may be reversed and the female spade terminal 104 may receive and host the male spade terminal 302 before the pair of push-in wire terminals 106A and 106B may receive and host the pair of wires 202 (one-to-one). Regardless of order, since the electrical connector 114 electrically connects (e.g., bridges) the pair of push-in wire terminals 106 and the female spade terminal 104, the electrical adapter 100 provides for an electrical adaption between the first device 200 and the second device 300. For example, the electrical adapter 100 may be a component of an HVAC system, although other applications are possible (e.g., a manufacturing system, an electrical system, a plumbing system, a vehicular system).

In some situations, the first device 200 may include a resistive load having current and voltage that are in-phase, such as lighting devices. heaters, small appliances, and other suitable resistive loads that do not impact or sufficiently impact a relevant power factor. Other examples include inductive loads which may have current that is offset behind voltage due to creation of a magnetic field, such as by a motor, a transformer, or other types of industrial equipment that cause power factor changes. Still other examples may include capacitive loads, which may have current that is offset leading voltage due to stored energy in an electric field, such as by a capacitor, or other types of energy storage. While the first device 200 is described as a single device, the first device 200 can include electrical networks of multiple load devices which can include any combination of resistive, inductive, and capacitive loads

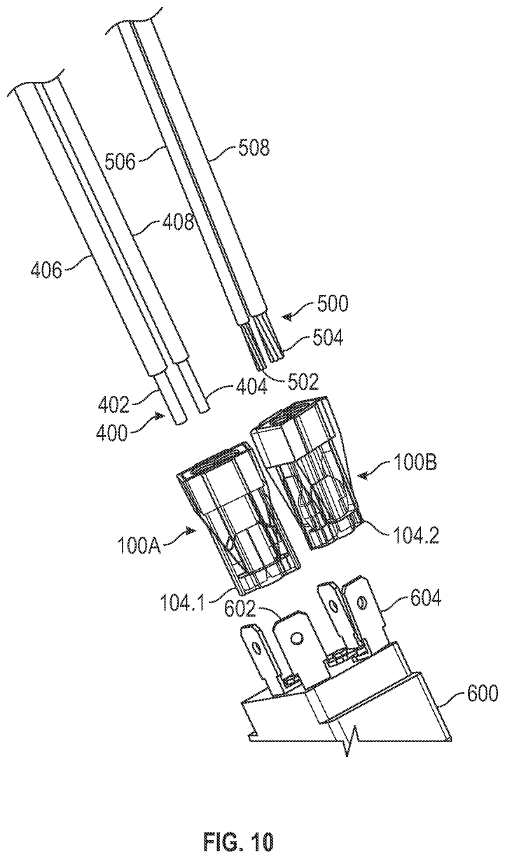

FIG. 10 is a perspective view of an embodiment of a schematic of a pair of electrical adapters, each as respectively depicted in FIGS. 1-8, each to respectively receive a pair of wires and each to respectively mate with a male spade terminal according to this disclosure. In particular, there may be a first electrical adapter 100A, a second electrical adapter 100B, a first pair of electrical conductors 400, a second pair of electrical conductors 500, and an electrical contactor 600.

Each of the first electrical adapter 100A and the second electrical adaptor 100B may be configured as described above.

The first pair of electrical conductors 400 may include a first electrical conductor 402 of a first gauge and a second electrical conductor 404 of a second gauge identical to the first gauge, although non-identical to the first gauge is possible, whether larger or smaller. The first electrical conductor 402 may be a first wire of the first gauge that may be sheathed by a first electrically insulating jacket 406, where the first wire may be a solid wire. The second electrical conductor 404 may be a second wire of the second gauge that may be sheathed by a second electrically insulating jacket 408, where the second wire may be a solid wire. The first electrical conductor 402 may extend parallel to the second electrical conductor 404, although this form of orientation is not required and non-parallel orientation is possible.

The second pair of electrical conductors 500 may include a first electrical conductor 502 of a first gauge and a second electrical conductor 504 of a second gauge not identical to the first gauge, whether larger or smaller, although identical to the first gauge is possible. The first electrical conductor 502 may be a first wire of the first gauge that may be sheathed by a first electrically insulating jacket 506, where the first wire may be a stranded wire. The second electrical conductor 504 may be a second wire of the second gauge that may be sheathed by a second electrically insulating jacket 508, where the second wire may be a stranded wire. The first electrical conductor 502 may extend parallel to the second electrical conductor 504, although this form of orientation is not required and non-parallel orientation is possible.

The electrical contactor 600 may include a first male spade terminal 602 and a second male spade terminal 604.

The first electrical adapter 100A includes the housing 102A hosting the push-in wire terminal 106A, the push-in wire terminal 106B, and the female spade terminal 104.1. The push-in wire terminal 106A may have the first receptacle 110A receiving and hosting the first electrical conductor 402, which may include the first electrically insulating jacket 406, and the push-in wire terminal 106B may have the second receptacle 110B receiving and hosting the second electrical conductor 404, which may include the second electrically insulating jacket 408. The female spade terminal 104.1 may receive and host the first male spade terminal 602 such that the female spade terminal 104.1 mates with the first male spade terminal 602.

The second electrical adapter 100B includes the housing 102B hosting the push-in wire terminal 106A, the push-in wire terminal 106B, and the female spade terminal 104.2. The push-in wire terminal 106A may have the first receptacle 110B receiving and hosting the first electrical conductor 502, which may include the first electrically insulating jacket 506, and the push-in wire terminal 106B may have the second receptacle 110B receiving and hosting the second electrical conductor 504, which may include the second electrically insulating jacket 508. The female spade terminal 104.2 may receive and host the first male spade terminal 604 such that the female spade terminal 104.2 mates with the first male spade terminal 604.

Based on above. the first electrical adapter 100A electrically and mechanically connects the first pair of electrical conductors 400 to the first male spade terminal 602 and the second electrical adapter 100B electrically and mechanically connects the second pair of electrical conductors 500 to the second male spade terminal 604. While FIG. 10 depicts solid conductors and stranded conductors in different electrical adapters 100, note that a single electrical adapter 100 can receive a mix of stranded conductors and solid conductors. Additionally, the single electrical adapter 100 can receive different gauges of conductors into the push-in wire terminal 106.

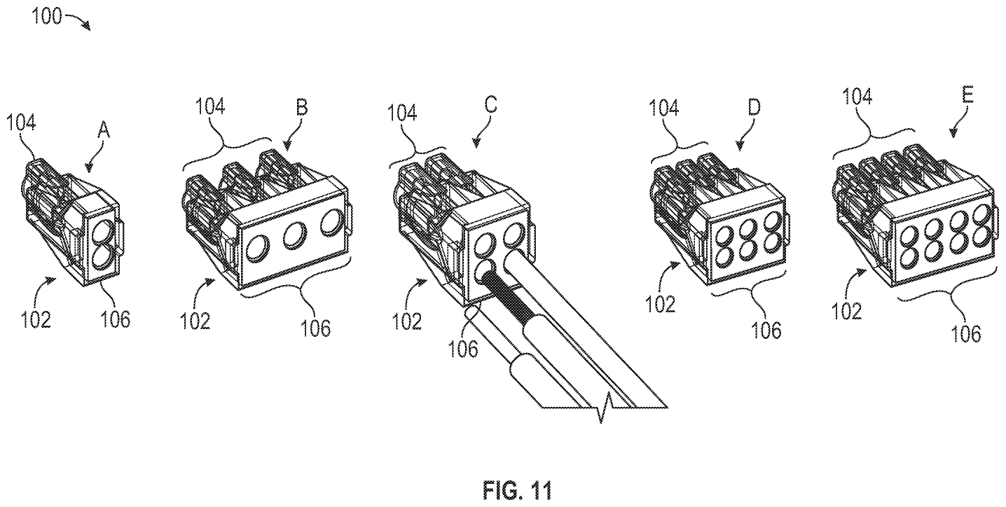

FIG. 11 is a perspective view of a set of embodiments of a set of electrical adapters, each depicted in FIGS. 1-8, that differ from each other in an amount of spade terminals or an amount of push-in wire terminals according to this disclosure. In particular, a set of electrical adapters 100 contain an electrical adapter A, an electrical adapter B, an electrical adapter C, an electrical adapter D, and an electrical adapter E, which may be configured as described above.

The electrical adapter A has the housing 102 hosting the female spade terminal 104 and two push-in wire terminals 106.

The electrical adapter B has the housing 102 hosting three female spade terminals 104 and three push-in wire terminals 106.

The electrical adapter C has the housing 102 hosting two female spade terminals 104 and four push-in wire terminals 106.

The electrical adapter D has the housing 102 hosting three female spade terminals 104 and six push-in wire terminals 106.

The electrical adapter E has the housing 102 hosting four female spade terminals 104 and eight push-in wire terminals 106.

As evident from above, any electrical adapter 100 may have the housing 102 hosting the female spade terminal 104 or the push-in wire terminal 106 of a same ratio or amount (e.g., two-two, three-three, four-four, even amount-even amount, odd amount-odd amount), or of a different ratio or amount (e.g., even amount-odd amount, odd amount-even amount, two-three, four-two, eight-one and so forth whether the female spade terminals 104 to the push-in wire terminals 106 or vice versa).

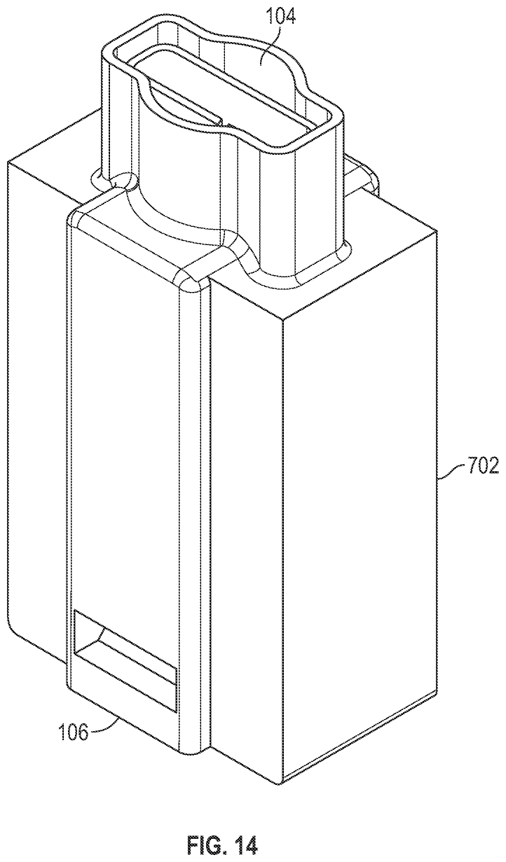

FIG. 14 is a perspective view of an embodiment of an electrical adapter according to this disclosure. In particular, there may be an electrical adapter 700 that may have a housing 702 that hosts (e.g., houses) the female spade terminal 104 and the push-in wire terminal 106. Unlike how the housing 102 is shaped, note that the housing 702 has a cuboid shape and omits the tapering portion 112.

Regardless of how the housing 102 or 702 is shaped, the housing 102 or 702 may host an indicia (e.g., a medium, a paper, a graphic) externally thereon (e.g., printed, embossed, adhered) to instruct a user on how to use the electrical adapter 100 or 700. Further, the user may be supplied (or provided or sent by mail or courier in a package or not in a package) the spade adapter 100 or 700 (or its variations or its components) and then instructed on its manufacture or use. For example, such form of instruction may include a printed manual, a presentation, a PDF file, a wizard, a webpage, a mobile app, a video content, an audio content, an augmented reality (AR) content, or another suitable instructional form factor, which may be provided simultaneous with the spade adapter 100 or 700 or separate therefrom. For example, there may be a package containing the electrical adapter 100 or the electrical adapter 700 or a set of electrical adapters 100, whether each member is structurally identical or not structurally identical, or a set of electrical adapters 700, whether each member is structurally identical or not structurally identical, whether including or not including an instructional content therewith (e.g., a manual, a diagram, a pictorial diagram, a schematic diagram). For example, the user may be enabled to access the electrical adapter 100 or the electrical adapter 700, extend the male terminal in the female spade adapter 104 and the electrical conductor in the push-in wire terminal 106 and energize the male spade terminal while the male spade terminal extends in the female spade terminal 104 (e.g., mates) or the electrical conductor while the electrical conductor extends in the push-in wire terminal 106. For example, the electrical adapter 100 or the electrical adapter 700 may be manufactured by an assembly method where the female spade terminal 104 is inserted into or attached to the housing 102 or the push-in wire terminal 106 is inserted into or attached to the housing 102, such that the female spade terminal 104 and the push-in wire terminal 106 are electrically coupled (e.g., connected) to each other via the housing 102, whether internally or externally, which may be via the electrical connector 114 hosted by the housing 102, whether internal or external.

Although various embodiments have been depicted and described in detail herein, skilled artisans know that various modifications, additions, substitutions and the like can be made without departing from this disclosure. As such, these modifications, additions, substitutions and like are considered to be within this disclosure.

What is claimed is:

1. A device, comprising:
an electrical adapter having a housing hosting a female spade terminal and a push-in wire terminal, wherein the female spade terminal is electrically coupled with the push-in wire terminal.

2. The device of claim 1, wherein the housing has an end portion hosting the female spade terminal.

3. The device of claim 1, wherein the housing has an end portion hosting the push-in wire terminal.

4. The device of claim 1, wherein the housing has a first end portion and a second end portion, wherein the first end portion hosts the female spade terminal, wherein the second end portion hosts the push-in wire terminal.

5. The device of claim 4, wherein the first end portion and the second end portion are opposite each other.

6. The device of claim 1, wherein the push-in wire terminal is a first push-in wire terminal, wherein the housing hosts a second push-in wire terminal.

7. The device of claim 6, wherein the female spade terminal is electrically coupled with the second push-in wire terminal.

8. The device of claim 7, wherein the female spade terminal is electrically coupled with the first push-in wire terminal and the second push-in wire terminal via a common electrical path.

9. The device of claim 6, wherein the housing has a side hosting the first push-in wire terminal and the second push-in wire terminal.

10. The device of claim 9, wherein the housing has an end portion having the side.

11. The device of claim 9, wherein the side hosts an odd number of push-in wire terminals including the first push-in wire terminal and the second push-in wire terminal, wherein the female spade terminal is electrically coupled with the odd number of push-in wire terminals.

12. The device of claim 9, wherein the side hosts an even number of push-in wire terminals including the first push-in wire terminal and the second push-in wire terminal, wherein the even number of push-in wire terminals includes four, wherein the female spade terminal is electrically coupled with the even number of push-in wire terminals.

13. The device of claim 6, wherein the housing hosts an odd number of push-in wire terminals including the first push-in wire terminal and the second push-in wire terminal, wherein the female spade terminal is electrically coupled with the odd number of push-in wire terminals.

14. The device of claim 6, wherein the housing hosts an even number of push-in wire terminals including the first push-in wire terminal and the second push-in wire terminal, wherein the even number of push-in wire terminals includes four, wherein the female spade terminal is electrically coupled with the even number of push-in wire terminals.

15. The device of claim 6, wherein the first push-in wire terminal and the second push-in wire terminal are of a same type or a mode of operation.

16. The device of claim 1, wherein the housing hosts the female spade terminal internally.

17. The device of claim 1, wherein the housing hosts the female spade terminal externally.

18. The device of claim 1, wherein the housing hosts the push-in wire terminal internally.

19. The device of claim 1, wherein the housing hosts the push-in wire terminal externally.

20. The device of claim 1, wherein the housing hosts the female spade terminal internally and the push-in wire terminal internally.

21. The device of claim 1, wherein the housing hosts the female spade terminal internally and the push-in wire terminal externally.

22. The device of claim 1, wherein the housing hosts the female spade terminal externally and the push-in wire terminal internally.

23. The device of claim 1, wherein the housing hosts the female spade terminal externally and the push-in wire terminal externally.

24. The device of claim 1, wherein the housing does not host any female spade terminals other than the female spade terminal.

25. The device of claim 1, wherein the female spade terminal is a first spade terminal, wherein the housing hosts a second spade terminal, wherein the second spade terminal is electrically coupled with the push-in wire terminal.

26. The device of claim 1, wherein the housing is shaped as a shape of a cube or a cuboid.

27. The device of claim 1, wherein the housing is shaped as a pyramid or a cone.

28. The device of claim 1, wherein the housing is shaped as a sphere or an oval.

29. The device of claim 1, further comprising:
a package containing the electrical adapter.

30. The device of claim 29, wherein the package contains a set of electrical adapters including the electrical adapter.

31. The device of claim 30, wherein each electrical adapter in the set of electrical adapters includes the housing hosting the female spade terminal and the push-in wire terminal, wherein the female spade terminal is electrically coupled with the push-in wire terminal.

32. The device of claim 1, wherein the housing is handheld.

33. The device of claim 1, wherein the housing includes a portion that includes a material that is electrically insulative.

34. The device of claim 1, wherein the housing includes a portion that includes a material that is transparent or translucent.

35. The device of claim 1, wherein the push-in wire terminal is capable of receiving a solid electrical conductor, a stranded electrical conductor, a solid electrical conductor and a stranded electrical conductor, or a combination or a hybrid of a solid electrical conductor and a stranded electrical conductor.

36. A method, comprising:
enabling an end user to:
access an electrical adapter having a housing hosting a female spade terminal and a push-in wire terminal, wherein the female spade terminal is electrically coupled with the push-in wire terminal;
extend a male spade terminal in the female spade terminal and an electrical conductor in the push-in wire terminal; and
energize the male spade terminal while the male spade terminal extends in the female spade terminal or the electrical conductor while the electrical conductor extends in the push-in wire terminal.

37. A method, comprising:
manufacturing an electrical adapter having a housing hosting a female spade terminal and a push-in wire terminal, wherein the female spade terminal is electrically coupled with the push-in wire terminal such that a male spade terminal is extendable in the female spade terminal and an electrical conductor is extendable in the push-in wire terminal and the male spade terminal is energizable while the male spade terminal extends in the female spade terminal or the electrical conductor is energizable while the electrical conductor extends in the push-in wire terminal.
